(19) United States
(12) Patent Application Publication
(10) Pub. No.: US 2021/0144912 A1
(43) Pub. Date: May 20, 2021

(54) DEVICE FOR HARVESTING ROOT FRUITS AND CORRESPONDING METHOD

(71) Applicant: EXEL INDUSTRIES, Epernay (FR)

(72) Inventor: Eduard RICHER, Hagelstadt/Gailsbach (DE)

(73) Assignee: EXEL INDUSTRIES, EPERNAY (FR)

(21) Appl. No.: 17/097,240

(22) Filed: Nov. 13, 2020

(30) Foreign Application Priority Data
Nov. 15, 2019 (DE) 10 2019 130 953.0

(51) Int. Cl. A01D 25/00; A01D 25/04

(52) U.S. Cl. CPC A01D 25/005; A01D 25/04

(57) ABSTRACT

A device for harvesting root fruits located in the ground is provided that may include a support frame, a pair of uprooting shares mounted on the support frame, which are designed to convey root fruits located in the ground out of the ground. The pair of uprooting shares defines a central plane (M-M) and is movably mounted on the support frame in a transverse direction (QR). The harvesting device has a guide device, which is designed to detect the position of a root fruit located in the ground and to be harvested and to guide the pair of uprooting shares in the transverse direction (QR) with respect to the root fruit to be harvested in the direction of a centered position.

### CROSS-REFERENCE TO RELATED APPLICATIONS

This application is a U.S. non-provisional application claiming the benefit of German Patent Application No. DE 10 2019 130 953.0, filed on Nov. 15, 2019, which is incorporated herein by reference in its entirety.

### FIELD OF THE INVENTION

The invention relates to a harvesting device for use with root fruits.

### BACKGROUND OF THE INVENTION

Uprooting devices are known which are used to uproot root fruits located in the ground, e.g., sugar beets. The known uprooting devices have a pair of uprooting shares, which take the root fruit to be uprooted between them and convey it out of the ground by means of the relative movement of the harvesting device and the ground. The uprooting shares are designed, for example, as wheel shares. The root fruits are generally sown in rows, but often grow offset from one another in the transverse direction, in different sizes and at different depths. This inhomogeneous structure of the root fruits to be harvested leads to a low yield at harvest, e.g., due to root breakage when being pulled out, due to roots being cut by the uprooting shares and due to wear of the uprooting shares.

The invention has the objective of rendering the harvesting process of the root fruits more efficient. The problem addressed by the present invention, in particular, is to remedy the disadvantages of the prior art and to keep root breakage, root cutting and/or uprooting share wear low. A further problem addressed is a simple mode of construction of the device.

### SUMMARY OF THE INVENTION

A harvesting device is provided that includes a support frame, at least one pair of uprooting shares that are mounted on the support frame, and which are designed to convey root fruits located in the ground out of the ground. The pair of uprooting shares defines a central plane (M-M) between them so that the uprooting shares are mounted movably on the support frame in a transverse direction (QR) to a harvesting direction (ER) of the harvesting device. In some embodiments, the harvesting device has a guide device, which is designed to detect the position of a root fruit located in the ground and to be harvested such that the pair of uprooting shares are guided in the transverse direction (QR) with respect to the root fruit to be harvested in the direction of a centered position.

In further advantageous embodiments each pair of uprooting shares may be a pair of wheel shares, where the wheel shares are mounted rotatably on the support frame. Each wheel share may have an uprooting edge. Further, each wheel share may have a disk-shaped form or a conical form, with each uprooting edge being substantially circular or comprising circular segments. Additionally, the guide device has at least one guide share, designed to contact the root fruit to be harvested, which precedes the pair of uprooting shares in the harvesting direction. At least one function of the relative position of the root fruit and of the first guide share is to move the pair of uprooting shares with respect to the support frame.

In other embodiments, the guide device has at least one second guide share which precedes the pair of uprooting shares, designed to contact the root fruit to be harvested, in the harvesting direction (ER). At least one function of the relative position of the root fruit and of the second guide share is to move the pair of uprooting shares with respect to the support frame. Also, each guide share may have a share leading edge and a share trailing edge. The share leading edge is often directed in the harvesting direction (ER) and the share trailing edge is often directed substantially towards the uprooting edge of the associated wheel share while being aligned with this uprooting edge. Each wheel share of a pair of uprooting shares extends in the harvesting direction away from the central plane (M-M). The share leading edge is further away from the central plane than the part of the uprooting edge, which is adjacent to the share trailing edge. In addition, each guide share may have an upper end and a lower end such that the harvesting device has a share radius SR which is the distance between an uprooting share axis and the uprooting edge.

Advantageously, the upper end, when viewed in the transverse direction, has a vertical distance DOE from the uprooting share axis, which is between 20% and 60%, and sometimes between 40% and 60% of the share radius SR. Often in this configuration, the lower end when viewed in the transverse direction has a vertical distance DUE from the uprooting share axis, which is between 80% and 100%, and sometimes between 90% and 100% of the share radius SR. The guide device may have a guide share carrier, which connects each guide share to the support frame or to the associated uprooting share. Each guide share carrier may be located on an inside portion between the uprooting shares of a pair and is often designed to strip contaminations, which can be located between the pair of uprooting shares, off of these uprooting shares.

A method is also provided for uprooting root fruits, in particular, sugar beets, utilizing the foregoing harvesting device applied to root fruits arranged in a row of root fruits so as to be conveyed out of the ground.

### BRIEF DESCRIPTION OF THE DRAWINGS

The invention is elucidated by means of the following description of a preferred embodiment, which refers to the accompanying drawings. The individual features of the claims and the description are to be regarded as disclosed in any combination or sub-combination, to the extent that they are not technically incompatible.

FIG. 1 shows a harvesting device according to the invention in a schematic side view as part of a harvesting machine according to the invention;

FIG. 2 shows the harvesting device according to the invention of FIG. 1 in a front view; and

FIG. 3 shows the harvesting device according to the invention in a view from below.

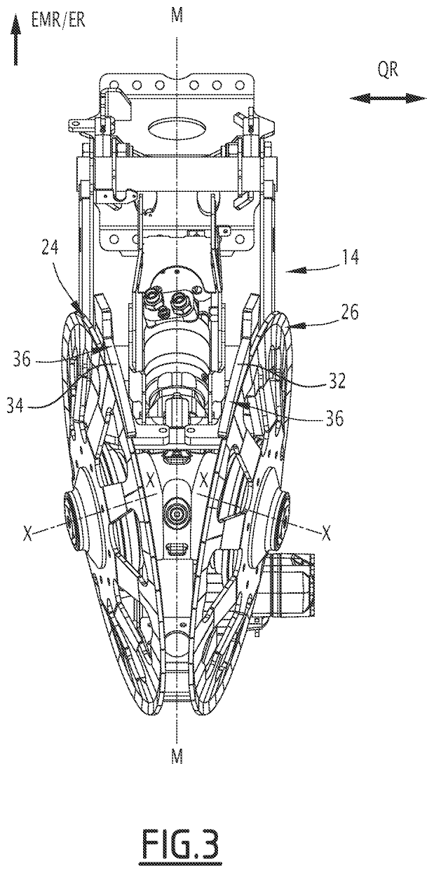

### DETAILED DESCRIPTION OF THE INVENTION

In the description of the invention suitability information is used such as “designed for this purpose” or “suitable for this purpose”, to the effect that the associated action is co-disclosed. For example, the expression “designed to uproot” also comprises the disclosure of “uproot”.

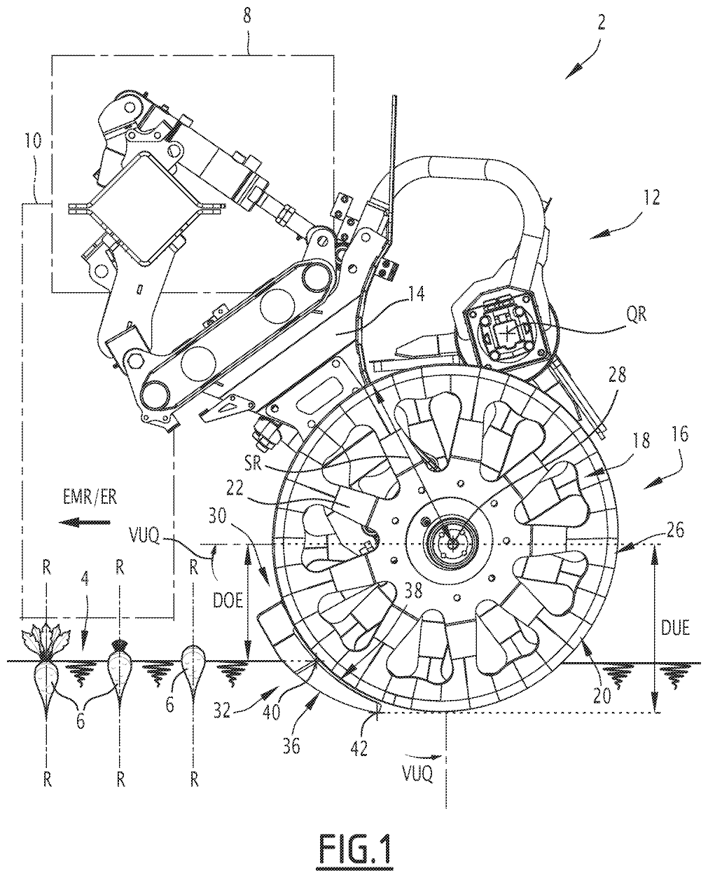

FIG. 1 shows schematically a harvesting machine 2 according to the invention.

The harvesting machine 2 is used for harvesting or uprooting root fruits located in the ground 4, in particular, beets 6 and in the present case sugar beets. The root fruits or sugar beets are generally referred to below as beets 6. Each beet 6 to be harvested has a central axis R-R, which is generally oriented vertically. The harvesting machine 2 defines a harvesting direction of travel EFR, which runs in FIG. 1 from right to left and which generally runs along a row of beets 6. The harvesting machine 2 has a machine frame 8, on which one or a plurality of beet pretreatment devices 10 indicated only schematically are mounted. These beet pretreatment devices 10 are, e.g., a flail, which cuts the leaves off of the beets 6 and/or an after topper, which cuts off the leaf bases of the beets 6.

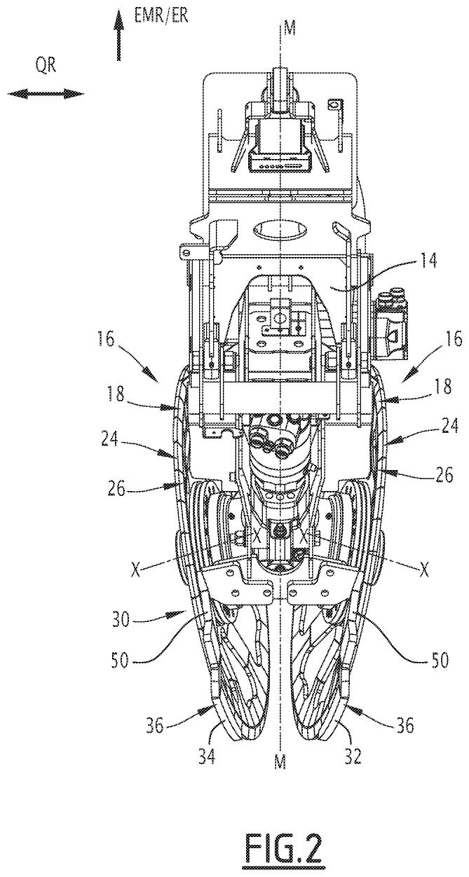

Furthermore, the harvesting machine 2 has a device 12 for harvesting or for uprooting beets 6 located in the ground 4. The harvesting device 12 has a support frame 14, with which the harvesting device is fastened on the machine frame 8. The support frame 14 can be adjustable in position with respect to the machine frame 8, e.g., via hydraulic cylinders and joints. Also, the harvesting device 12 has a pair or two uprooting shares 16 mounted on the support frame 14. The uprooting shares 16, or the pair of uprooting shares 16 are designed to convey beets 6 located in the ground out of the ground. For this purpose, the two uprooting shares 16 are arranged substantially V-shaped or diverging in the harvesting direction of travel EFR. The uprooting shares 16 define a central plane M-M (see FIG. 2) between them, wherein the central plane generally runs centrally between the uprooting shares 16. If the harvesting machine is on a horizontal plane, the central plane M-M is vertical and parallel to a longitudinal plane of the harvesting machine 12. The central plane M-M extends parallel to the drawing plane of FIG. 1. The pair of uprooting shares 16 may be formed as a pair of wheel shares 18. Each wheel share 18 may be mounted rotatably around a wheel share axis X-X on the support frame 14. The or each wheel share 18 of the pair extends in the harvesting direction ER or in the harvesting direction of travel EFR away from the central plane M-M.

The harvesting device 12 defines a harvesting direction ER, which corresponds to a harvesting direction of travel EFR. The harvesting device defines a transverse direction QR, which runs in a plane perpendicular to the harvesting direction ER and, when the harvesting device is in use, runs substantially horizontally and runs perpendicular to the central plane M-M.

The uprooting shares 16 are movably or displaceably mounted on the support frame 14 in the transverse direction QR to the harvesting direction ER. Each wheel share 18 has a conical form, which preferably has an opening angle of at least 150°. Alternatively, each wheel share 18 has a disk-shaped form. Each wheel share 18 has, with respect to its wheel share axis X-X, a substantially circular uprooting edge 20 or an uprooting edge comprising circular segments. The uprooting edge 20 can also consist substantially of circular segments. Each wheel share 18 comprises two opposing side surfaces 22.

The uprooting edge 20 is formed by an edge end face 24 and two edge side surfaces 26 adjoining it. The edge side surfaces 26 are angled in the present example with respect to the side surfaces 22 and are in the shape of a circular ring segment. Each wheel share 18 is fastened rotatably on the support frame 14 via a hub 28. The harvesting device 12 defines a share radius SR, which is the distance between the wheel share axis X-X and the uprooting edge 20.

The harvesting device 12 has a guide device 30, which is designed to detect the position of a beet 6 located in the ground and to be harvested and to guide the pair of uprooting shares 16 in the transverse direction QR with respect to the beet 6 to be harvested in the direction of a centered position. The centered position is the position, in which the beet 6 is located in the harvesting direction of travel EFR or in the harvesting direction ER centrally between the uprooting shares 16 of the pair of uprooting shares, in order to be conveyed out of the ground 4. In other words, the centered position is the position of the uprooting shares 16, in which a central axis R-R of the beet 6 to be harvested lies in the central plane M-M.

The guide device 30 has a first guide share 32, which precedes the pair of uprooting shares 16 in the harvesting direction ER. More precisely, the first guide share 32 precedes a first uprooting share of the pair of uprooting shares 16 and is assigned to it. The first guide share 32 is designed to contact the beet 6 to be harvested, which is located in the ground and, as a function of the relative position of the beet 6 and the first guide share, to move the pair of uprooting shares with respect to the support frame 14 in the transverse direction QR. This movement is thereby directed, so that it is directed towards the centered position.

The guide device 30 has a second guide share 34, which precedes the pair of uprooting shares 16 in the harvesting direction ER. More precisely, the second guide share 34 precedes a second uprooting share of the pair of uprooting shares 16 and is assigned to it. The second guide share 34 is designed to contact the beet 6 to be harvested, which is located in the ground and, as a function of the relative position of the beet 6 and the second guide share 34 to move the pair of uprooting shares 16 with respect to the support frame in the transverse direction QR. This movement is thereby directed so that it is directed towards the centered position. The movement of the pair of uprooting shares 16 generated by the first guide share 32 is opposite to the movement of the pair of uprooting shares 16 generated by the second guide share 34.

Each of the first 32 and second 34 guide shares has a share leading edge 36 and a share trailing edge 38, wherein the share leading edge is directed substantially forwards in the harvesting direction ER and the share trailing edge is directed substantially towards the uprooting edge 20 of the associated or assigned wheel share and is aligned with this uprooting edge 20.

The share leading edge 36 is preferably arc-shaped. Alternatively, the share leading edge 36 can also be straight or have another form. The share trailing edge 38 is arc-shaped and its radius corresponds substantially to the radius SR of the assigned uprooting edge 20 or is somewhat larger than the latter. The share leading edge 36 of each guide share 32 or 34 is further away from the central plane M-M than the part of the uprooting edge 20 of the asigned wheel share 18, which is adjacent to the share trailing edge 38. The distance in the transverse direction QR of the two coulder leading edges of the guide shares 32, 34 of a pair of wheel shares 18 is greater than the distance in the transverse direction QR of the uprooting edges 20 of this pair of wheel shares 18 measured at the same height as the distance between the share leading edges.

Each guide share 32,34 is arranged substantially in alignment with the side surfaces 22 or edge side surfaces 26 of the assigned wheel share. Each guide share 32, 34 has side surfaces, which extend substantially in parallel or co-planar with the side surfaces 22 or edge side surfaces 26. Each guide share 32, 34 has an upper end 40 and a lower end 42. The upper end 40 of each guide share 32, 34 has, when viewed in the transverse direction QR (therefore perpendicular to the plane of FIG. 1), a vertical distance DOE from the uprooting share axis X-X, which is between 20% and 60%, and preferably between 40% and 60% of the share radius SR. The lower end 42 of each guide share 32, 34 has, when viewed in the transverse direction QR, a vertical distance DUE from the uprooting share axis X-X, which is between 80% and 100% and preferably between 90% and 100% of the share radius SR. The position of the uprooting share axis X-X for determining the above distances is determined in the wheel share hub.

Each wheel share 20 defines a front, lower quandrant VUQ. This front lower quandrant VUQ is delimited substantially, on the one hand, by a horizontal half-plane from the wheel share center point in the direction of the harvesting direction and a vertical half-plane, which runs downwards from the wheel share center point. Each of the first and second guide shares 32, 34 extends exclusively in the front lower quandrant VUQ of the assigned wheel share 18.

The guide device 30 has one guide share carrier 50 (FIG. 2) per guide share 32, 34, which connects each of the first 32 or second 34 guide shares to the support frame or to the assigned uprooting share 16. The guide share carrier 50 is connected rigidly in the transverse direction to the uprooting share 16 and, e.g., is fastened on the gear housing of the uprooting shares 16. The uprooting share 16 is, however, rotatable with respect to the guide share carrier 50 or the guide shares. Each guide share carrier 50 is located on the inside between the uprooting shares 16 of the assigned pair of uprooting shares 16. Each guide share carrier 50 is designed to strip contaminations, which are located between this pair of uprooting shares, off of these uprooting shares.

The inventive harvesting device makes possible an efficient orientation of the uprooting shares, in particular, of the wheel shares 18, to the beets 6 to be harvested. With the guide shares 32, 34 the usable opening of the harvesting device is enlarged forwards, so that large beets can be uprooted less deeply and thus the shares can be centered on the beets.

The use of the harvesting device involves one or a plurality of the following successive steps:

The harvesting device is moved in the harvesting direction on a ground with a row of beets to be harvested.

At least one first or one second guide share contacts a beet to be harvested, while the central axis of said beet is outside of the central plane M-M.

By contacting the first or second guide share 32, 34 of the beet 6 to be harvested the pair of uprooting shares 16 on the transverse beam 14 is moved on the transverse beam 14, so that the central plane of the central axis of the beet is approached or coincides with the said beet.

The beet 6 to be harvested is conveyed out of the ground by the uprooting shares. 16.

Alternatively, the harvesting device has only one guide share 32 and no second guide share 34.

The above description provides a pair of uprooting shares/guide shares. The harvesting machine generally has one pair of said shares per row of root fruits to be harvested, e.g., six pairs.

1. A device for harvesting root fruits located in the ground, having:
a support frame,
at least one pair of uprooting shares mounted on the support frame, which are designed to convey root fruits located in the ground out of the ground,
wherein the pair of uprooting shares defines a central plane (M-M) between them,
wherein the uprooting shares are mounted movably on the support frame in a transverse direction (QR) to a harvesting direction (ER) of the harvesting device,
characterized in,
that the harvesting device has a guide device, which is designed
to detect the position of a root fruit located in the ground and to be harvested and
to guide the pair of uprooting shares in the transverse direction (QR) with respect to the root fruit to be harvested in the direction of a centered position.

2. The harvesting device according to claim 1, wherein
the or each pair of uprooting shares is a pair of wheel shares,
the wheel shares are mounted rotatably on the support frame, and
each wheel share has an uprooting edge.

3. The harvesting device according to claim 2, wherein each wheel share
has a disk-shaped form or a conical form or
the or each uprooting edge is substantially circular or comprises circular segments.

4. The harvesting device according to claim 1, wherein the guide device has at least one guide share,
which precedes the pair of uprooting shares in the harvesting direction and
which is designed to contact the root fruit to be harvested and, as a function of the relative position of the root fruit and of the first guide share, to move the pair of uprooting shares with respect to the support frame.

5. The harvesting device according to claim 4, wherein the guide device has at least one second guide share,
which precedes the pair of uprooting shares in the harvesting direction (ER) and
which is designed to contact the root fruit to be harvested and, as a function of the relative position of the root fruit and of the second guide share, to move the pair of uprooting shares with respect to the support frame.

6. The harvesting device according to claim 2, wherein
the guide device has at least one guide share,
which precedes the pair of uprooting shares in the harvesting direction and
which is designed to contact the root fruit to be harvested and, as a function of the relative position of the root fruit and of the first guide share, to move the pair of uprooting shares with respect to the support frame,
wherein the or each guide share has a share leading edge and a share trailing edge, wherein the share leading edge is directed in the harvesting direction (ER) and the share trailing edge is directed substantially towards the uprooting edge of the associated wheel share and is aligned with this uprooting edge.

7. The harvesting device according to claim 6, wherein each wheel share
has a disk-shaped form or a conical form or
the or each uprooting edge is substantially circular or comprises circular segments.

8. The harvesting device according to claim 6, wherein the guide device has at least one second guide share,
which precedes the pair of uprooting shares in the harvesting direction (ER) and
which is designed to contact the root fruit to be harvested and, as a function of the relative position of the root fruit and of the second guide share, to move the pair of uprooting shares with respect to the support frame.

9. The harvesting device according to claim 6, wherein the or each wheel share of a pair of uprooting shares extends in the harvesting direction away from the central plane (M-M) and the share leading edge is further away from the central plane than the part of the uprooting edge, which is adjacent to the share trailing edge.

10. The harvesting device according to claim 4, wherein
each guide share has an upper end and a lower end,
the harvesting device has a share radius SR which is the distance between an uprooting share axis and the uprooting edge and
wherein the upper end, when viewed in the transverse direction, has a vertical distance DOE from the uprooting share axis, which is between 20% and 60% or between 40% and 60% of the share radius SR or
wherein the lower end when viewed in the transverse direction has a vertical distance DUE from the uprooting share axis, which is between 80% and 100% or between 90% and 100% of the share radius SR.

11. The harvesting device according to claim 1, wherein the guide device has a guide share carrier, which connects each guide share to the support frame or to the associated uprooting share.

12. The harvesting device according to claim 1, wherein each guide share carrier is located on the inside between the uprooting shares of a pair and is designed to strip contaminations, which are located between the pair of uprooting shares, off of these uprooting shares.

13. A method for uprooting root fruits, in particular, sugar beets, characterized in that with a harvesting device according to claim 1, root fruits of a row of root fruits are conveyed out of the ground.
